(19) United States
(12) Patent Application Publication
(10) Pub. No.: US 2007/0016809 A1
(43) Pub. Date: Jan. 18, 2007

(54) POWER SUPPLY DEVICE

(75) Inventors: Yasuhiko KIDA, Osaka (JP); Tetsuya MAEDA, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/457,151

(22) Filed: Jul. 13, 2006

(30) Foreign Application Priority Data
Jul. 13, 2005 (JP) 2005-204389

(51) Int. Cl. G06F 1/00

(52) U.S. Cl. 713/300

(57) ABSTRACT

A power supply device is disclosed in which a power supply control unit thereof includes (i) a sleep mode switch that switches the device from a ready mode to a sleep mode, and at the same time, turns off a display, if a predetermined condition is satisfied, (ii) a sleep operation mode switch that switches the device from the sleep mode to a sleep operation mode if a job request is received during the sleep mode from an external device that is connected to the power supply device via a network, and switches the sleep operation mode to the sleep mode if the requested job is completed during the sleep operation mode, and (iii) an input operation detector that detects an input operation made during the sleep operation mode. The sleep operation mode switch switches the device to the ready mode if the input operation detector detects an input operation during the sleep operation mode.

### CROSS-REFERENCE TO RELATED APPLICATIONS

This application claims priority to Japanese Patent Application No. 2005-204389. The entire disclosure of Japanese Patent Application No. 2005-204389 is hereby incorporated herein by reference.

### BACKGROUND OF THE INVENTION

1. Field of the Invention

The present invention relates to a power supply device comprising a plurality of control units and a power supply control unit. The control units correspond to a plurality of functions, and comprise a job execution control unit configured to execute a predetermined job and an operation control unit configured to display predetermined information and receive an input operation. The power supply control unit is configured to control the power that is supplied to a predetermined control unit amongst the plurality of the control units, based on the operational status of each of the plurality of the control units.

2. Field of the Invention

Recent image forming devices such as copying machines comprise a local user interface (local UI) and a remote user interface (remote UI), and thus can execute processes such as image output by means of a remote operation from a single or a plurality of information processing devices (external device(s)), as well as by means of an operation from the main unit of the image processing device.

In addition, Japanese Patent Application Publication JP-A-2001-274928 discloses an image forming device having a sleep mode switch. The sleep mode switch will switch the ready mode of the image forming device, in which power is supplied to each of control units, to a sleep mode in which the power supply to a predetermined control unit is suspended if an operation control unit has not been operated for a predetermined period of time, so as to reduce the power consumption thereof. One major control unit to which power supply is suspended is a job execution control unit that will execute a predetermined job. In addition, the display of predetermined information in an operation control unit that displays the predetermined information and receives input operations will be turned off, for instance. Moreover, the image forming device is configured so that a sleep operation mode switch will switch the sleep mode to a sleep operation mode in which power is supplied to the job execution control unit if a job request is received from an external device connected to a network during the sleep mode, and switches the sleep operation mode to the sleep mode if the requested job is completed during the sleep operation mode.

However, in the above described conventional art, even if a job request input operation is performed through the operation control unit during the sleep operation mode, the sleep operation mode will not be canceled. In addition, when a job requested from an external device connected to a network is completed, the sleep operation mode will be switched to the sleep mode. Therefore, one problem that will arise is that a job request input through the operation control unit will be cleared.

In view of the above, it is an object of the present invention to provide a power supply device that can properly set a low power consumption mode in response to the way the user is operating the device. This invention will address this need in the art as well as other needs, which will become apparent to those skilled in the art from this disclosure.

### SUMMARY OF THE INVENTION

In order to achieve the above described object, a power supply device in accordance with a first aspect of the present invention comprises a plurality of control units, including a job execution control unit configured to execute a predetermined job, and an operation control unit configured to display predetermined information and receive an input operation, and a power supply control unit configured to control the power supply to one or more predetermined control units based on the operational status of each of the control units. The power supply control unit comprises (i) a sleep mode switch configured to switch the power supply device from a ready mode, in which power is supplied to each of the control units, to a sleep mode, in which at least the power supply to the job execution control unit is suspended, and at the same time, turn off the display that is executed by the operation control unit if a predetermined condition is satisfied, (ii) a sleep operation mode switch configured to switch the power supply device from the sleep mode to a sleep operation mode, in which power is supplied to the job execution control unit, if a job request is received during the sleep mode from one or a plurality of external devices connected to the power supply device via a network, and switch the sleep operation mode to the sleep mode if the requested job is completed during the sleep operation mode, and (iii) an input operation detector configured to detect an input operation from the operation control unit during the sleep operation mode. The sleep operation mode switch will switch the power supply device to the ready mode if the input operation detector detects an input operation during the sleep operation mode.

According to the first aspect of the present invention, the sleep operation mode switch will switch the power supply device from the sleep mode to the sleep operation mode, in which power is supplied to the job execution control unit, if a job request is received during the sleep mode from one or a plurality of external devices connected to a network. In addition, the sleep operation mode switch will switch the power supply device from the sleep operation mode to the sleep mode if the requested job is completed during the sleep operation mode. Therefore, it is possible to reduce power consumption. Furthermore, the sleep operation mode switch will switch the power supply device from the sleep operation mode to the ready mode if the input operation detector detects an input operation during the sleep operation mode. Therefore, a job request input by a user via the operation control unit will not be cleared during the sleep operation mode. Accordingly, it is possible to have the job execution control unit execute a predetermined job with respect to a job request. In other words, it is possible to provide a power supply device that will properly set a low power consumption mode in response to usage status.

According to a second aspect of the present invention, in the above described first aspect of the present invention, the power supply control unit further comprises a display switch configured to turn on the display executed by the operation control unit during the sleep operation mode, and the sleep operation mode switch is configured to switch the power supply device to the ready mode if the display switch turns on the display executed by the operation control unit during the sleep operation mode.

For example, the above described configuration makes it possible to preset the display switch so as to turn on or turn off the display executed by the operation control unit during the sleep operation mode. In addition, the above described configuration makes it possible for the sleep operation mode to be switched to the sleep mode or the ready mode when the job requested by one or a plurality of external devices is completed during the sleep operation mode. In other words, it is possible to freely set the power consumption mode to a low power consumption mode or an even lower power consumption mode in accordance with usage status.

As described above, according to the present invention, it is possible to provide a power supply device that can properly set a low power consumption mode in accordance with usage status.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 shows the function block configuration of the control blocks relating to power supply control in a power supply device in accordance with one embodiment of the present invention;

FIG. 2 shows a digital copying machine and information processing devices connected via a local area network (LAN);

FIG. 3 shows the configuration of the digital copying machine of FIG. 2;

FIG. 4 shows the operation panel of the digital copying machine of FIG. 2;

FIG. 5 shows the configuration of the function blocks in several control units of the digital copying machine of FIG. 2;

FIG. 6 is a flowchart showing the power supply control operation for the control blocks shown in FIG. 1;

FIG. 7 shows the function block configuration of the control blocks relating to power supply control in a power supply device in accordance with another embodiment of the present invention; and

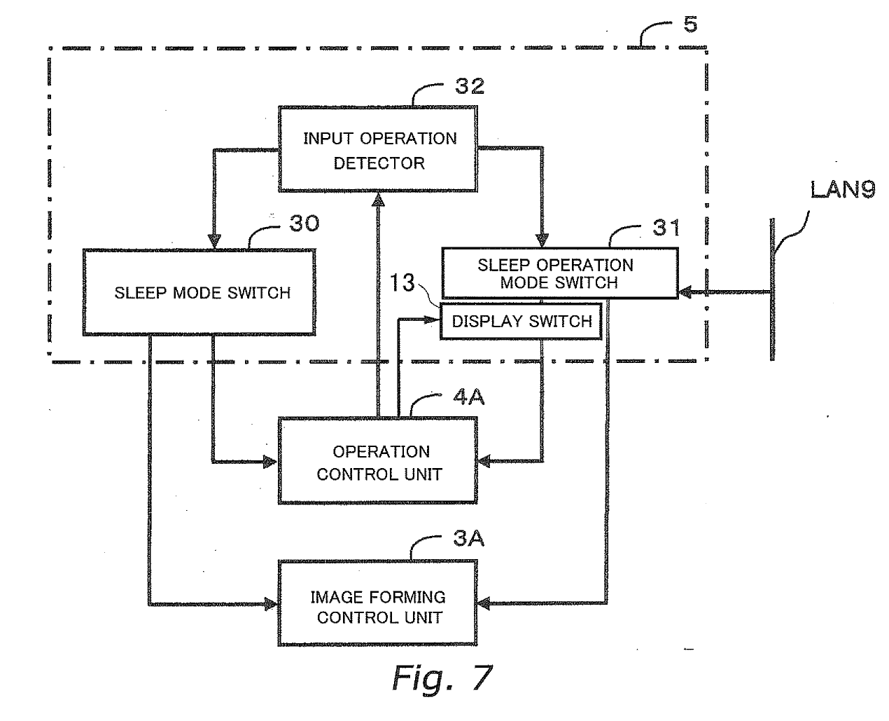

FIG. 8 is a flowchart showing the power supply control operation of the control block shown in FIG. 7.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

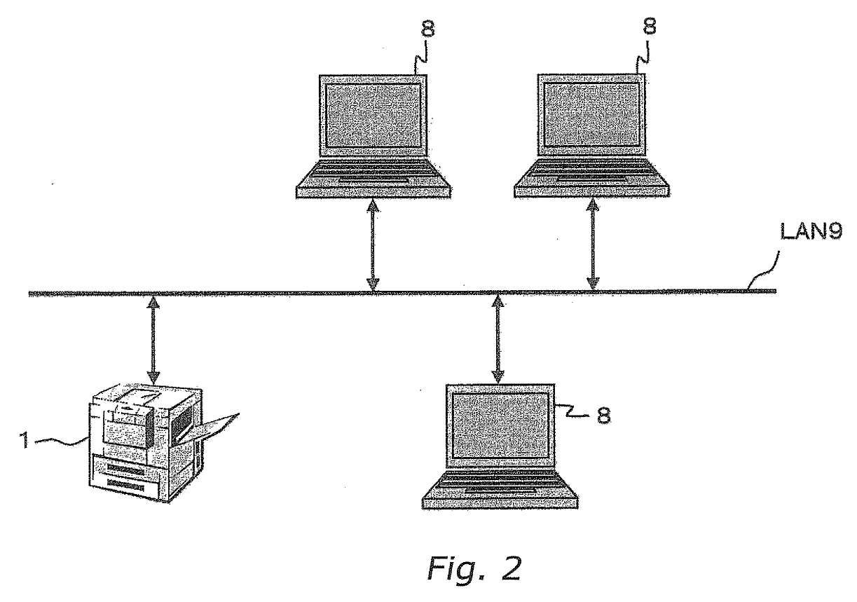

An embodiment in which the power supply device of the present invention is applied to a digital copying machine 1 will be described below. As shown in FIG. 2, the digital copying machine 1 is connected to a single or a plurality of information processing devices 8 (external devices), which respectively comprise a remote user interface (remote UI), via a network transmission device such as a local area network (LAN) 9. In addition, the information processing device(s) is/are configured to transmit one or more job requests to the digital copying machine 1.

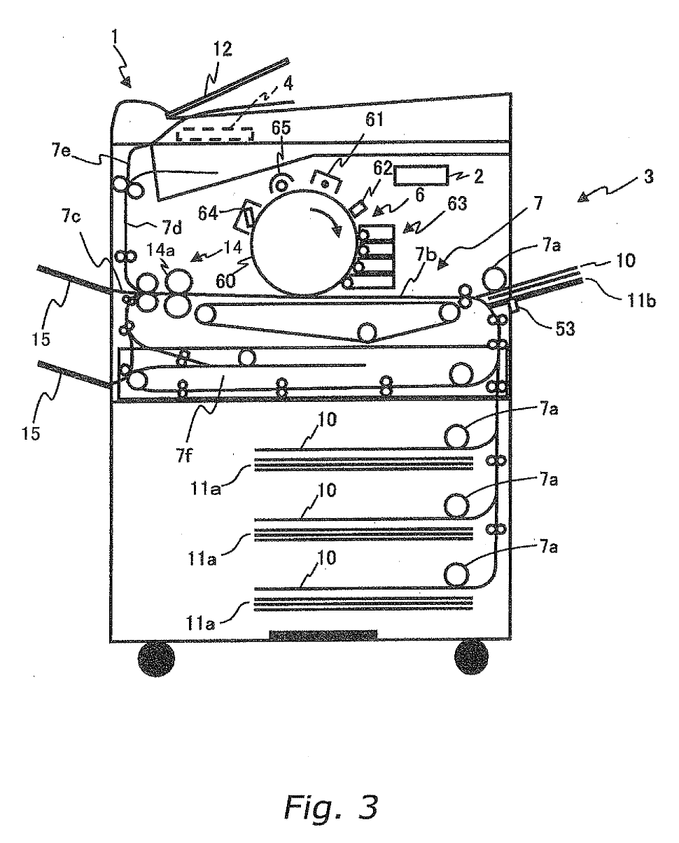

As shown in FIG. 3, the digital copying machine 1 comprises an image scanner, an output image data generator 2, an image forming unit 3, and an operation panel 4. The image scanner scans the image data of a document. The output image data generator 2 generates output image data by executing a predetermined process for the document image data scanned by the image scanner. The image forming unit 3 forms an image on a recording sheet 10 (e.g., a sheet of paper) based on the output image data generated by the output image data generator 2. Mode configuration keys for setting the operation mode for a job to be executed by the digital copying machine 1, and a print button for activating the job that was set, are arranged on the operation panel 4. In addition, the operation panel 4 comprises a liquid crystal display (LCD) touch panel on which the configuration information set by the mode configuration keys is displayed.

The image scanner comprises a document tray 12 on which a document can be placed, a document feeder (not shown in the figure) configured to feed the document placed on the document tray 12 into the digital copying machine 1, and a charge-coupled device (CCD) linear sensor (not shown in the figure) configured to scan the image on the document fed by the document feeder.

The image forming unit 3 comprises a toner image forming unit 6, a conveyance unit 7, and a fixing unit 14. The toner image forming unit 6 forms a toner image on a photoreceptor 60 based on the output image data. The conveyance unit 7 conveys the recording sheet 10 on which the formed toner image is to be transferred. The fixing unit 14 comprises a fixing roller 14a. The fixing roller 14a is heated to a predetermined temperature by a heater (not shown in the figure) and a temperature sensor (not shown in the figure), both of which are arranged in the interior of the fixing unit 14. The fixing unit 14 fixes the toner image transferred onto the recording sheet 10 by using the heated fixing roller 14a to heat and melt the toner image.

The toner image forming unit 6 comprises the photoreceptor 60, an electrostatic charger 61, a print head 62, a developing unit 63, a transfer unit, a cleaner 64, and a charge removing lamp 65. The electrostatic charger 61, the print head 62, the developing unit 63, the transfer unit, the cleaner 64, and the charge removing lamp 65 are sequentially arranged around the photoreceptor 60. The electrostatic charger 61 uniformly charges the surface of the photoreceptor 60 with a corona charge. The print head 62 forms an electrostatic latent image by exposing the electrostatically charged photoreceptor 60. The developing unit 63 electrostatically adheres toner to the formed electrostatic latent image and develops the image into a toner image. The transfer unit transfers the toner image onto the recording sheet 10. The cleaner 64 removes toner remaining on the photoreceptor 60 after the transfer of the toner image. The charge removing lamp 65 removes the residual electric potential on the surface of the photoreceptor 60. Note that four color (i.e., cyan, magenta, yellow, and black) developing blocks are arranged in the developing unit 63 so that a color image can be generated.

The conveyance unit 7 comprises sheet feed conveyance members 7a, a transfer conveyance member 7b, a first sheet discharge member 7c, a second sheet discharge member 7d, a third sheet discharge member 7e, and a reverse conveyance member 7f. The sheet feed conveyance member 7a conveys the recording sheets 10 one at a time from one or more standard sheet feed cassettes 11a in which a plurality of the recording sheets 10 with different sizes are respectively stored, or from a manual sheet feed cassette 11b on which a variety of different sizes of recording sheets 10 can be set. The transfer conveyance member 7b will convey a recording sheet 10 fed therein to the transfer unit, and then conveys the recording sheet 10 on which the toner image was transferred to the fixing unit 14. The first sheet discharge member 7c discharges the recording sheet 10 that passed through the fixing unit 14 to a sheet discharge tray 15 so as to face upward. The second sheet discharge member 7d discharges the recording sheet 10 so as to face downward. The third sheet discharge member 7e conveys the recording sheet 10 to the image scanner by way of the second sheet discharge member 7d. The reverse conveyance member 7f is used when two-sided printing is to be executed. Note that a conveyance roller is provided with each of these members, respectively.

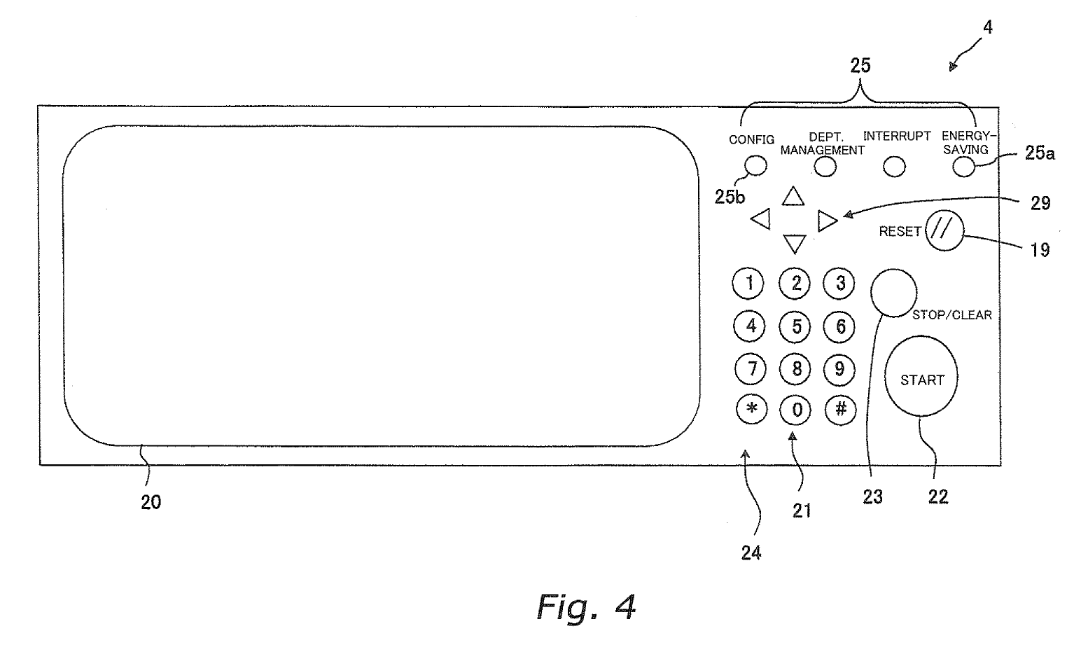

The operation panel 4 is arranged on the front side of the image scanner. As shown in FIG. 4, the operation panel 4 comprises a color liquid crystal display (LCD) touch panel 20 functioning as an image display on the left side thereof, and an operation input key group 24 on the right side thereof that comprises a variety of keys. The operation input key group 24 is comprised of a basic control key group used for copy operations, and a special mode configuration key group 25, for instance. The basic control key group includes numeric keys 21 for setting the number of copies, a start key 22, a clear/stop key 23, arrow keys 29, and a reset key 19.

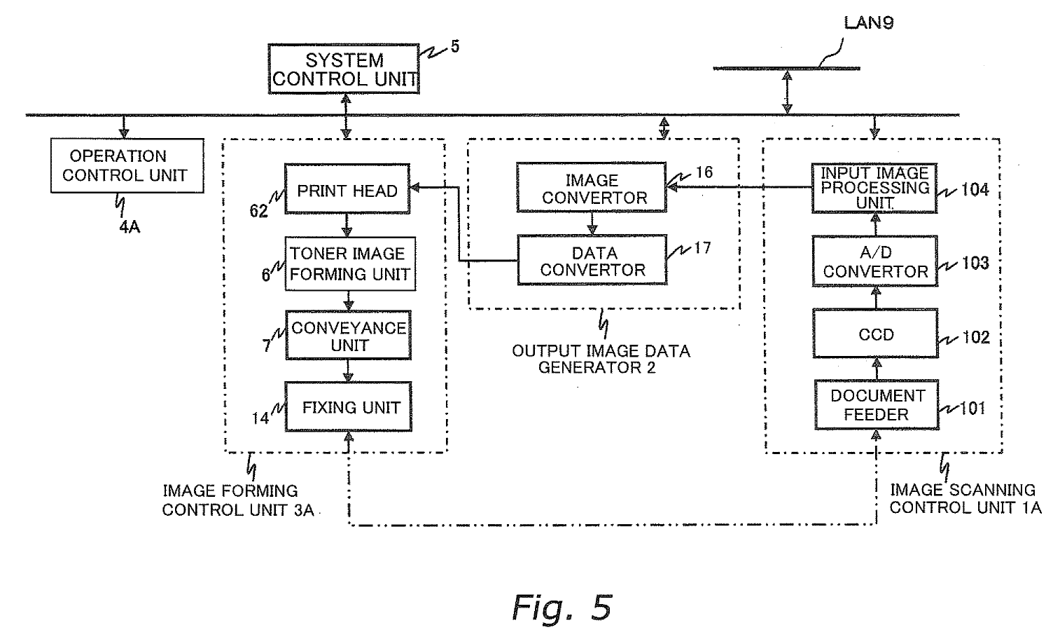

As shown in FIG. 5, the control units of the digital copying machine 1 (i.e., the power supply device of the present invention) comprise an image scanning control unit 1A, the output image data generator 2, an image forming control unit 3A, an operation control unit 4A, and a system control unit 5. The image scanning control unit 1A controls the document scanning operation executed by the image scanner. The image forming control unit 3A controls the image forming unit 3. The operation control unit 4A controls the input/output signals transmitted to/from the operation panel 4. The system control unit 5 controls the execution of operations, such as copy operations, by controlling the timing of each of the above described control blocks, that is, the image scanning control unit 1A, the output image data generator 2, the image forming control unit 3A, and the operation control unit 4A. In addition, a CPU and a ROM in which an operation program controlled by the CPU is stored are provided with each of the above described control blocks, that is, the image scanning control unit 1A, the output image data generator 2, the image forming control unit 3A, the operation control unit 4A, and the system control unit 5.

The image scanning control unit 1A is configured to drive a document feeder 101 so as to feed a document placed on the document tray 12, and control an input image processing unit 104 comprised of a predetermined conversion table in order to execute shading compensation and gamma control with respect to image data, and is produced by converting an analog signal corresponding to the document image scanned by a charge-coupled device (CCD) linear sensor 102 to digital data by means of an analog-digital (A/D) converter 103.

The output image data generator 2 comprises an image converter 16 and a data converter 17. The image converter 16 is configured to execute an image data conversion process such as spatial filtering, halftone processing, and zoom processing, with respect to the image data output from the input image processing unit 104. The data converter 17 is configured to convert the output image data from the image converter 16 into a drive signal for driving the print head 62. In addition, the drive signal converted from the output image data is configured to be output to a driving circuit of the print head 62.

A copy operation will be initiated in the digital copying machine 1 when the following operations are sequentially executed. First, a document will be placed on the document tray 12, and a configuration operation will be performed with the mode configuration keys on the operation panel 4 in order to set the number of copies, the output sheet size, and the copy magnification, and then the print button is pushed. A copy operation can also be started when the digital copying machine 1 receives a job request transmitted from the information processor 8. In other words, the system control unit 5 will output a command to scan the document to the image scanning control unit 1A, output a command to generate an output image based on the scanned image data to the output image data generator 2, and output a command to output an image to the image forming control unit 3A. The image forming control unit 3A will drive the conveyance unit 7 so as to convey the recording sheet 10 from the sheet feed cassette 11a or the manual sheet feed cassette 11b, and then the system control unit 5 will output a command to output image data to the image forming control unit 3A at a predetermined timing so as to drive the print head 62. When a toner image is formed on the photoreceptor 60 exposed by the print head 62, the toner image is transferred onto the recording sheet 10. Then, the fixing unit 14 will execute a fixing process with respect to the recording sheet 10, and the recording sheet 10 will be discharged out of the copying machine.

In addition, the system control unit 5 is configured to also act as a power supply control unit 5 that controls the power supply to a predetermined control block based on the operational state of each of the above described control blocks.

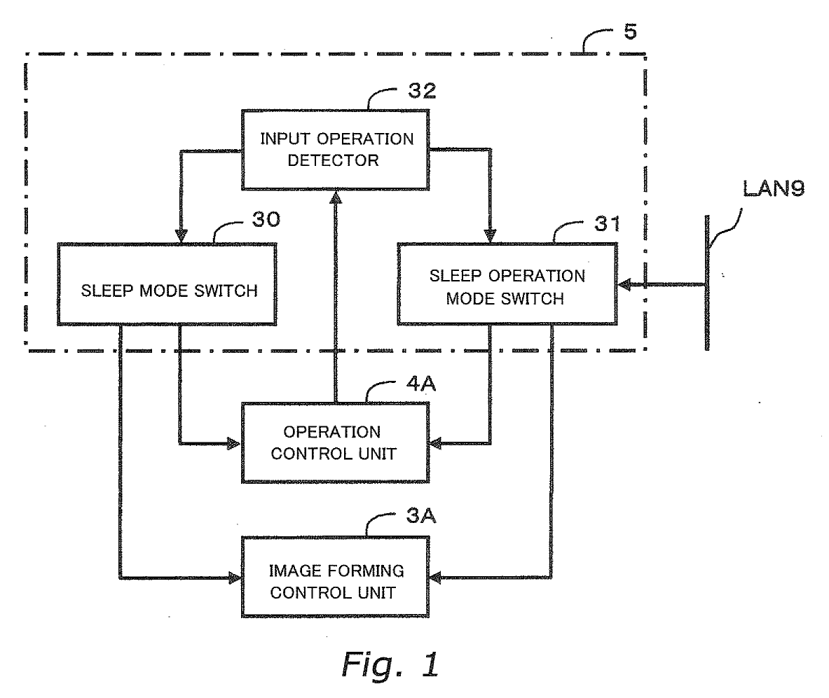

As shown in FIG. 1, the function block configuration of the system control unit 5 will, when functioning as the power supply control unit 5, comprise a sleep mode switch 30, a sleep operation mode switch 31, and an input operation detector 32. If a predetermined condition is satisfied, the sleep mode switch 30 will switch the digital copying machine 1 from a ready mode, in which power is supplied to each of the control blocks, to a sleep mode, in which the power supplied to the image forming control unit 3A (functioning as a job execution control unit that executes a predetermined job) will be suspended. At the same time, the display executed by the operation control unit 4A that will display predetermined information and receive input operations will be turned off. The sleep operation mode switch 31 will switch the digital copying machine 1 from the sleep mode to a sleep operation mode, in which power is supplied to the image forming control unit 3A, if a job request is received from one or a plurality of information processing devices 8 that is/are connected to the network via the LAN 9 during the sleep mode, and switch the digital copying machine 1 from sleep operation mode to the sleep mode if the requested job is completed during the sleep operation mode. The input operation detector 32 will detect input operations from the operation control unit 4A at least during the sleep operation mode.

The sleep mode switch 30 will switch the digital copying machine 1 from the ready mode, in which power is supplied to each of the above described control blocks, to the sleep mode, in which the power supplied to a predetermined control block is suspended, if a predetermined condition is satisfied, so as to reduce the power consumption of the digital copying machine 1. For example, the sleep mode switch 30 is configured to suspend the power supply to the image forming control unit 3A and switch the ready mode to the sleep mode, in which the display of predetermined information on the color LCD 20 executed by the operation control unit 4A is turned off, if an energy-saving key 25a is provided in the special mode configuration key group 25 and is operated, or if the input operation detector 32 does not detect an input operation on the operation panel 4 via the operation control unit 4A for more than a predetermined period of time Tₜₕ.

Note that an internal clock that transmits constant frequency clock signals and an internal counter that counts the clock signals is provided in the digital copying machine 1, and the clock and counter will be used to detect whether the predetermined period of time Tₜₕ has elapsed. More specifically, the internal counter is reset every time an input operation on the operation panel 4 is detected via the operation control unit 4A, and whether or not the predetermined period of time has elapsed will be detected based on the preset predetermined period of time Tₜₕ and the value counted by the internal counter after the internal counter is reset.

The sleep operation mode switch 31 is configured to switch the digital copying machine 1 from the sleep mode to the sleep operation mode, in which power is supplied to the image forming control unit 3A while display of predetermined information on the color LCD 20 executed by the operation control unit 4A remains turned off, so as to reduce power consumption in the digital copying machine 1 as much as possible, even if a job request from one or a plurality of information processing devices 8 connected to the network via the LAN 9 is received during the sleep mode. In addition, if the requested job is completed during the sleep operation mode, the sleep operation mode switch 31 is configured to switch the sleep operation mode to the sleep mode.

Furthermore, if the input operation detector 32 detects an input operation on the operation panel 4 via the operation control unit 4A, the sleep operation mode switch 31 is configured to switch the digital copying machine 1 from sleep operation mode to the ready mode by supplying power to each of the above described control blocks.

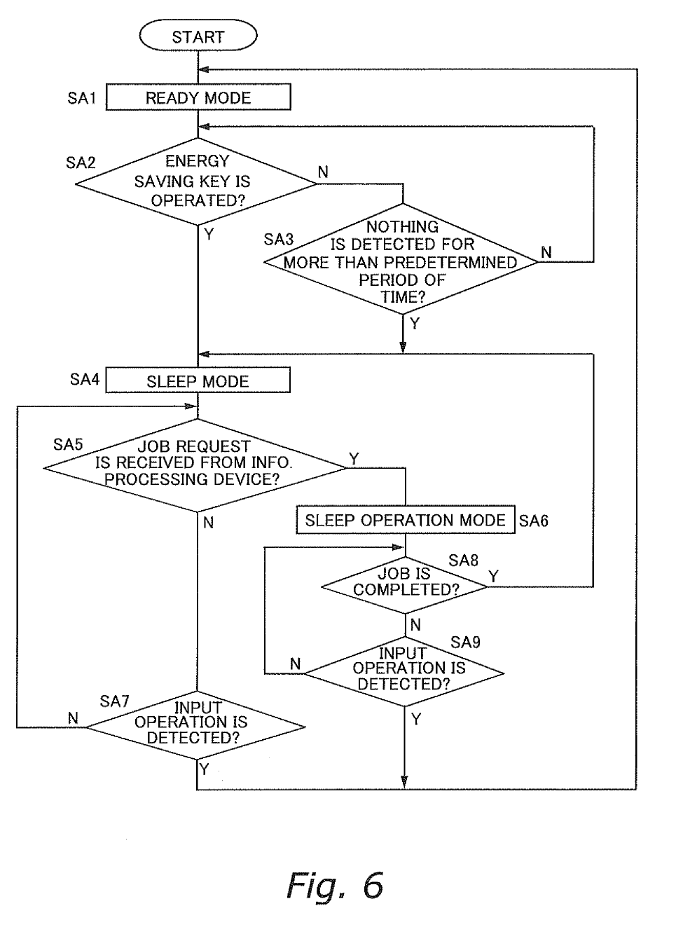

Next, the operation of the power supply control for the control blocks executed by the power supply control unit 5 will be hereinafter explained with reference to the flow chart shown in FIG. 6. If the main power of the digital copying machine 1 is turned on, the power supply control unit 5 will supply power to each of the above described control blocks. In other words, the digital copying machine is set to be in the ready mode in which power is supplied to each of the control blocks (Step SA1).

If the energy-saving key 25a is operated (Step SA2), or if the input operation detector 32 does not detect an input operation via the operation panel 4 through the operation control unit 4A for more than the predetermined period of time Tₜₕ (Step SA3), the sleep mode switch 30 will switch the digital copying machine 1 from ready mode to the sleep mode, in which the power supply to the image forming control unit 3A is suspended, and at the same time as this, the display of predetermined information on the color LCD 20 executed by the operation control unit 4A is turned off (Step SA4).

If the sleep operation mode switch 31 receives a job request from one or a plurality of information processing devices 8 connected to a network through the LAN 9 (Step SA5), the sleep operation mode switch 31 will switch from the sleep mode to the sleep operation mode, in which power is supplied to the image forming control unit 3A while the display of predetermined information on the color LCD 20 executed by the operation control unit 4A remains turned off (Step SA6).

In addition, if the input operation detector 32 detects an input operation on the operation panel 4 via the operation control unit 4A during the sleep mode (Step SA7), the sleep mode switch 30 will switch the digital copying machine 1 from the sleep mode to the ready mode by supplying power to each of the above described control blocks (Step SA3). On the other hand, if the job requested by one or a plurality of information processing devices 8 is completed during the sleep operation mode (Step SA8), the sleep operation mode switch 31 will switch from the sleep operation mode to the sleep mode by suspending the power supply to the image forming control unit 3A (Step SA4).

Furthermore, if the input operation detector 32 detects an input operation on the operation panel 4 via the operation control unit 4A during the sleep operation mode (Step SA9), the sleep operation mode switch 31 will switch the digital copying machine 1 from the sleep operation mode to the ready mode by supplying power to each of the control blocks (Step SA3).

In other words, if the sleep operation mode switch receives a job request from one or more of the external devices connected to the network during the sleep mode, the sleep operation mode switch will switch the device from the sleep mode to the sleep operation mode, in which power is supplied to the job execution control unit, and will switch from the sleep operation mode to the sleep mode if the requested job is completed during the sleep operation mode. Accordingly, it is possible to reduce power consumption. In addition, if the input operation detector detects an input operation during the sleep operation mode, the sleep operation mode switch will switch the device from the sleep operation mode to the ready mode. Therefore, a job request input by a user during the sleep operation mode via the operation control unit will not be cleared, and thus it is possible to have the image forming control unit 3A execute a predetermined job in response to the job request.

Alternative embodiments will be hereinafter explained. In addition to the above described embodiment, the power supply control unit 5 may be configured to further comprise a display switch 13 that turns on the display of the color LCD 20 executed by the operation control unit 4A during the sleep operation mode.

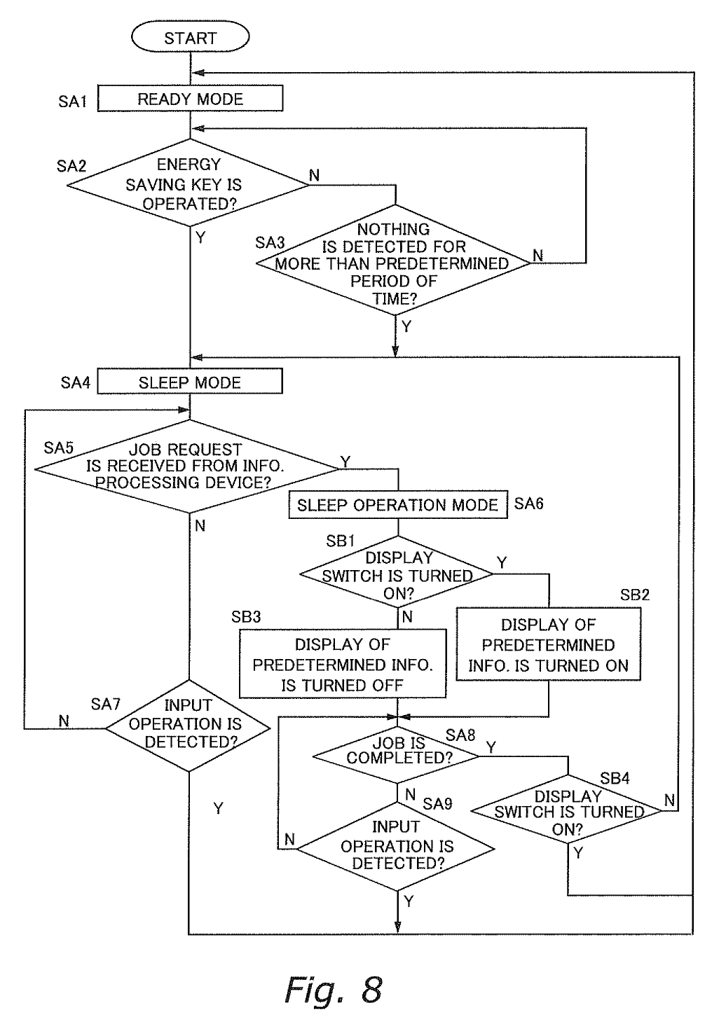

For example, the display switch 13 will turn the display of the color LCD 20 off during the sleep operation mode when in a default configuration mode that is started by operation of a default configuration key 25b in the special mode configuration key group 25. As shown in FIG. 8, if the display switch 13 is set to be off (No in Step SB1), the sleep operation mode switch 31 will turn off the display of predetermined information on the color LCD 20 during the sleep operation mode (Step SB3), as is the case with the above described embodiment. In addition, if the job(s) requested by the information processing device(s) 8 is/are completed during the sleep operation mode (Yes in Step SA8, then No in Step SB4), the power supply to the image forming control unit 3A will be suspended, and thus the sleep operation mode will be switched to the sleep mode (Step SA4). On the other hand, if the display switch 13 is set to be on (Yes in Step SB1), the display of the predetermined information on the color LCD 20 executed by the operation control unit 4A will be turned on during the sleep operation mode (Step SB2). In addition, if the job(s) requested by the information processing device(s) 8 is/are completed during the sleep operation mode (Yes in Step SA8, then Yes in Step SB4), power will be supplied to each of the control blocks, and thus the sleep operation mode will be switched to the ready mode (Step SA1).

In other words, it is possible to freely set the power consumption mode to be a low power consumption mode, or an even lower power consumption mode, according to the usage status.

Note that the above described embodiment is only an example of the present invention, and the design of the present invention, such as the specific configuration of each of the blocks, may be freely changed without departing from the scope of the present invention.

In the above described embodiment, a configuration is described in which the power supply device in accordance with the present invention applied to a digital copying machine. However, the power supply device in accordance with the present invention is not limited to this, and can be applied to a device such as a facsimile machine with a scanner unit, a multifunctional device with a printer function and a facsimile function, and the like.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments

What is claimed is:

1. A power supply device, comprising:
a plurality of control units comprising a job execution control unit configured to execute a predetermined job, and an operation control unit configured to display predetermined information and receive an input operation; and
a power supply control unit configured to control the power supplied to one or plurality of predetermined control units based on an operational status of each of the control units;
the power supply control unit comprising:
a sleep mode switch configured to switch the power supply device from a ready mode in which power is supplied to each of the control units, to a sleep mode in which the power supplied to at least the job execution control unit is suspended, and at the same time, turn off the display executed by the operation control unit, if a predetermined condition is satisfied;
a sleep operation mode switch configured to switch the power supply device from the sleep mode to a sleep operation mode, in which power is supplied to the job execution control unit if a job request is received from one or a plurality of external devices connected to the power supply device via a network during the sleep mode, and switch the sleep operation mode to the sleep mode if the requested job is completed during the sleep operation mode; and
an input operation detector configured to detect an input operation from the operation control unit during the sleep operation mode, the sleep operation mode switch switching the sleep operation mode to the ready mode if the input operation detector detects an input operation during the sleep operation mode.

2. The power supply device according to claim 1, wherein
the power supply control unit further comprises a display switch configured to turn on the display executed by the operation control unit during the sleep operation mode; and
the sleep operation mode switch is configured to switch the power supply device to the ready mode if the display switch turns on the display.
